(19) United States
(12) Patent Application Publication
(10) Pub. No.: US 2010/0315348 A1
(43) Pub. Date: Dec. 16, 2010

(54) DATA ENTRY-ENHANCING TOUCH SCREEN SURFACE

(75) Inventors: Roger J. JELLICOE, VERNON HILLS, IL (US); Jason P. WOJACK, LIBERTYVILLE, IL (US)

Correspondence Address: PATENTS ON DEMAND, P.A.-Motorola, 4581 WESTON ROAD, SUITE 345, WESTON, FL, 33331, US

(73) Assignee: MOTOROLA, INC., SCHAUMBURG, IL (US)

(21) Appl. No.: 12/482,872

(22) Filed: Jun. 11, 2009

(51) Int. Cl. G06F 3/041; G06F 3/033

(52) U.S. Cl. 345/173; 715/863

(57) ABSTRACT

Touch screen data entry accuracy can be improved utilizing a touch screen interface coupled with a computing device and a data entry-enhancing touch screen surface. The touch screen interface can include a sensory system that can be configured to detect input sensations predefined input areas displayed within a graphical user interface (GUI). The data entry-enhancing touch screen surface can include one or more focused entry depressions that can be configured to centrally direct an activation device into a user-desired input area. Each focused entry depression can be spatially aligned with a predefined input area of the GUI. The activation of additional predefined input areas of the GUI that are within close proximity to the user-desired input area can be reduced.

### BACKGROUND

The present invention relates to the field of touch screen computing interfaces and, more particularly, to a data entry-enhancing touch screen surface.

Computing devices have become commonplace and an integral part of daily life. Due to their versatility, touch screens are a popular interface choice for many different types of computing devices and systems, such as point-of-sale (POS) systems and portable multi-media devices. Unlike interfaces that utilize static mechanical input keys, touch screens allow software applications to dynamically present various configurations of graphical input keys or areas within the same interface.

However, a typical touch screen is void of the visible and tactile features that assist in improving the data entry accuracy for conventional mechanical input interfaces. For example, a computer keyboard peripheral has keys that have physical spacing and whose contact surface is textured and/or slightly concave to assist in fingertip placement. These features allow a user to alter finger placement prior to hitting a key.

Although a graphical user interface (GUI) rendered by the touch screen can visually illustrate spacing between input areas, the actual touch screen does not provide any physical barriers that correspond to the spacing. As such, multiple input areas of the touch screen are often inadvertently activated, causing processing problems for the touch screen's software and frustration for the user. Further, input areas are often inadvertently activated during transport of the computing device when objects come into contact with the touch screen.

Attempts to improve the data entry accuracy of touch screens have focused on post-input feedback. For example, a user is provided with an audible or tactile alert when input areas have been activated. These approaches do not prevent the user from making the incorrect selection, but provide feedback for selections. Thus, current approaches do not proactively improve the data entry accuracy for the touch screen.

### BRIEF SUMMARY

One aspect of the present invention can include a system for improving touch screen data entry accuracy. Such a system can include a touch screen interface coupled with a computing device and a data entry-enhancing touch screen surface. The touch screen interface can include a sensory system that can be configured to detect input sensations from predefined input areas displayed within a graphical user interface (GUI). The data entry-enhancing touch screen surface can include one or more focused entry depressions that can be configured to centrally direct an activation device into a user-desired input area. Each focused entry depression can be spatially aligned with a corresponding predefined input area of the GUI. The activation of additional predefined input areas of the GUI that are within close proximity to the user-desired input area can be reduced, improving the data input accuracy for the user-desired input area prior to sensing by the touch screen interface.

Another aspect of the present invention can include a data entry-enhancing touch screen surface that can include one or more focused entry depressions that can be configured to centrally direct an activation device into a user-desired input area. Each focused entry depression can be spatially aligned with a corresponding predefined input area of the GUI. The activation of additional predefined input areas of the GUI that are within close proximity to the user-desired input area can be reduced, improving the data input accuracy for the user-desired input area prior to sensing by the touch screen interface.

Yet another aspect of the present invention can include a graphical user interface (GUI) element alignment method. According to the method, when in a first application state, a set of GUI elements can be visually rendered within a touch screen interface. Each of the GUI elements can be spatially aligned with a focused entry depression. A touch of the focused entry depression when in the first application state can be interpreted as input selecting the corresponding GUI element. Each focused entry depression represents a deviation from an otherwise planar reference plane of a touch surface, wherein touches on the touch surface correspond to user entered input for the touch screen interface. An application event can be detected that causes a change from the first application state to a second application state. A graphical user interface can be automatically adjusted from the first application state to the second application state responsive to detecting the application event. In a second application state, the GUI elements associated with the first application state can be changed. That is, when in the second application state, a touch of the focused entry depression can be interpreted differently than a similar touch made when in the first application state would be interpreted.

When a software application controlling a touch screen interface is in a first state, control elements of a graphical user interface (GUI) can be visually rendered such that each control element can be spatially aligned with a focused entry depression of a data entry-enhancing touch screen surface. The placement of an activation device within the focused entry depression can activate a control element. When the software application controlling the touch screen interface is in a second state, information can be visually presented within a designated viewing area of the touch screen interface. The presentation of information can disregard spatial alignment with the focused entry depressions. In this state, placement of the activation device within a focused entry depression does not activate the touch screen interface.

### BRIEF DESCRIPTION OF THE SEVERAL VIEWS OF THE DRAWINGS

FIG. 1 is a schematic diagram illustrating a system that improves the data entry accuracy of a touch screen interface in accordance with embodiments of the inventive arrangements disclosed herein.

FIG. 1A is a schematic diagram illustrating a jacket encapsulation embodiment of a data entry-enhancing touch screen surface in accordance with embodiments of the inventive arrangements disclosed herein.

FIG. 1B is a schematic diagram illustrating a mechanical attachment mechanism embodiment of a data entry-enhancing touch screen surface in accordance with embodiments of the inventive arrangements disclosed herein.

FIG. 1C is a schematic diagram illustrating an integrated surface embodiment of a data entry-enhancing touch screen surface in accordance with embodiments of the inventive arrangements disclosed herein.

FIG. 2 is a collection of alternate detailed views of a data entry-enhancing touch screen surface in accordance with an embodiment of the inventive arrangements disclosed herein.

FIG. 3 contains schematic diagrams of views that illustrate the use of popple actuation couplings to differentiate sensations detected using the data entry-enhancing touch screen surface in accordance with an embodiment of the inventive arrangements disclosed herein.

FIG. 4 is a flow chart of a method 400 for handling deviations to a touch surface within touch screen software in accordance with an embodiment of the inventive arrangements disclosed herein.

### DETAILED DESCRIPTION

One embodiment of the present invention discloses a data entry-enhancing touch screen cover for improving the data input accuracy of a touch screen interface. The data entry-enhancing touch screen cover can include one or more focused entry depressions that correspond to selection areas or buttons displayed within a graphical user interface (GUI) of the touch screen interface. A focused entry depression can be shaped and sloped to guide an activation device towards the center of the selection area, thereby, decreasing accidental activation of nearby selection areas. The touch screen cover can either permit “touches” to be conveyed through it to be sensed by an underlying sensors associated with a device or include cover specific sensors, which are capable of sensing touch inputs, which are in turn conveyed to the computing device.

One contemplated embodiment, alters a surface (either using a cover overlay or be altering the screen itself) of a touch screen device from a straight plain to a surface having multiple deviations from the plane of the touch screen. The touch screen device can accept finger input via any number of touch screen technologies, including but not limited to, capacitive technologies, optical imaging technologies, and resistive technologies. Each deviation can correspond (at least part of the time depending upon application/device state) to a GUI element proximately located to the deviation. For example, a touch screen can be physically modified to have depressions or dimples that correspond to keys of a number pad, keyboard, and/or thumb pad. Touch input directed towards the GUI elements can be focused by the physical deviations of the touch surface.

The GUI elements being part of a graphical user interface can be dynamically changeable in purpose and position. For example, by default a layout template having selectable options corresponding to surface deviations (e.g., dimples) can exist, where a meaning of presses to specific ones of these depressions varies by device state (i.e., in a “number” input mode touches corresponding to dial pad elements can be mapped to digits; in an alpha input mode, the same touches can correspond to letters). Additionally, device states can exist where no GUI element is located proximate to surface deviations of a touch screen. For instance, a mobile phone can include a touch screen with a dial pad having dimples corresponding to each dial pad “key”. Then the mobile phone is displaying an image and/or playing a video, a layout template can be suppressed and no GUI elements will be presented on the device (in a picture or video mode) proximate to the surface deviations of the touch screen.

In embodiments using one or more removable covers with surface deviations, software of a device can be optionally designed to detect when a cover is being used or not, which can cause events to fire and be detected that automatically adjust an application state of a device. That is, when a dial pad cover is positioned over a touch screen, an application state for dial pad input (where GUI elements correspond to each dial pad depression) can be invoked; when an keyboard cover is positioned over a touch screen, an application state for keyboard input can be invoked; and, when no cover is used, a default GUI for the device can be invoked.

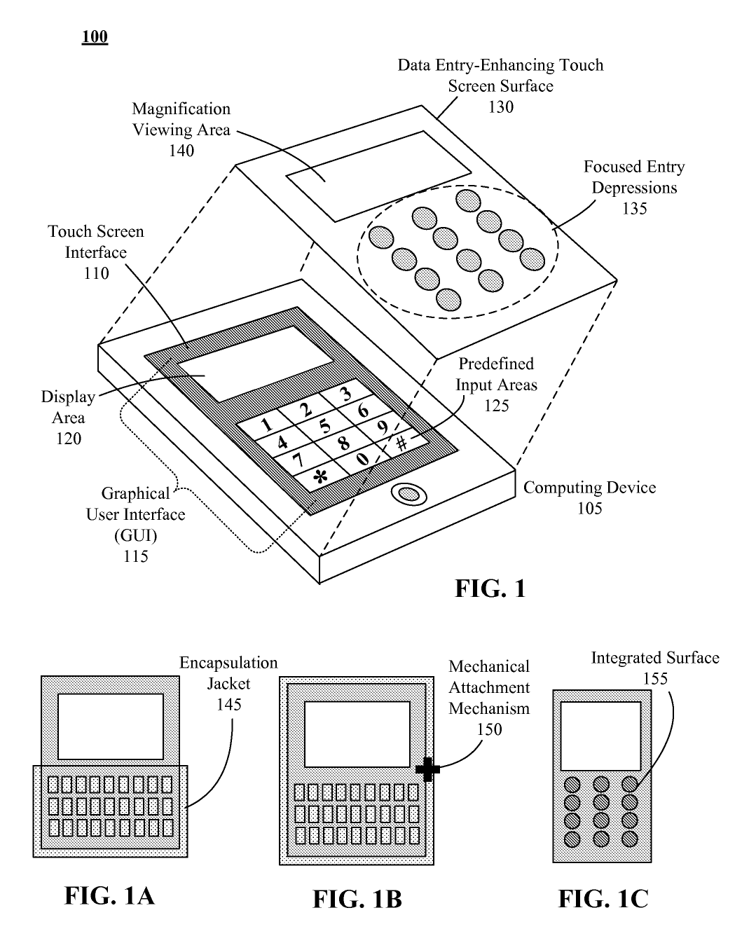

FIG. 1 is a schematic diagram illustrating a system 100 that improves the data entry accuracy of a touch screen interface 110 in accordance with embodiments of the inventive arrangements disclosed herein. In system 100, a data entry-enhancing touch screen surface 130 (e.g., a cover) can be positioned upon a computing device 105 having a touch screen interface 110.

The computing device 105 can represent a variety of electronic devices capable of presenting data upon and communicating with the touch screen interface 110. Examples of the computing device 105 can include, but are not limited to, a smart phone, a personal data assistant (PDA), a laptop, a portable multi-media device, a mobile phone, a computing kiosk, a surface-computing system, and the like. Each of the computing devices 105 can include a central processing unit (CPU), a volatile memory, a non-volatile memory, connected to each other via a bus. Computer program products (e.g., software, firmware) stored on the computing device 105 can run on the device. In one embodiment, these computer program products can include a general purpose operating system, such as a LINUX based OS.

A touch screen interface 110 can represent an interaction mechanism that identifies input based on the location of the activation device, such as a stylus or finger, upon the screen. The location of the activation device can be determined based upon the sensory mechanism implemented within the touch screen interface 110 and/or computing device 105. The sensory mechanism can include, but is not limited to, resistive feedback sensing, capacitive sensing, surface-wave acoustic (SAW) sensing, infrared (IR) sensing, projected capacitive sensing, strain gauge sensing, dispersive signal sensing, acoustic pulse recognition sensing, optical image sensing, and optical sensing. Sensory mechanisms, such as capacitive sensing and optical image sensing, which operate effectively in a presence of the surface 130 and/or a non-uniform plane (touch surface) can be situationally preferred over others. That being stated, the surface 130 and touch sensing technology of a system 100 can be designed to specifically interoperate. For example, if a resistive sensing technique can be used in which case surface 130 can be somewhat flexible (at least in regions corresponding to depressions 135).

The touch screen interface 110 can present a graphical user interface (GUI) 115 by which a user can interact with the computing device 105. The GUI 115 can include a display area 120 for presenting data and one or more predefined input areas 125. The predefined input areas 125 can represent bounded locations of the touch screen interface 110 that, when the activation device is detected within a predefined input area 125, the software (not shown) associated with touch screen interface 110 recognizes the input sensation as relating to the execution of programmatic instructions associated with the selected visual element. That is, when a user presses the area of the dial pad 115 displaying the pound sign (#) 125 in this example, the touch screen interface 110 knows that the pound sign 125 was selected and performs the corresponding action.

A data entry-enhancing touch screen surface 130 can be utilized to improve the accuracy of predefined input area 125 selections made by a user utilizing the GUI 115 presented in the touch screen interface 110. The data entry-enhancing touch screen surface 130 can encompass the entirety or only a portion of the touch screen interface 110 and can include concavities called focused entry depressions 135 that can be spatially aligned with the predefined input areas 125 of the GUI 115.

Further, the data entry-enhancing touch screen surface 130 can be of a transparent nature that does not inhibit viewing the GUI 115 presented within the touch screen interface 110. As an additional feature, the data entry-enhancing touch screen surface 130 can optionally include a magnification viewing area 140 to produce an enlarged presentation of an underlying area of the touch screen interface 110.

The focused entry depressions 135 can be configured to direct a stylus or finger towards the center of the depression, and, thus, the corresponding predefined input area 125. Because an activation device is drawn into the focused entry depression 135, the inadvertent activation of neighboring predefined input areas 125 can be reduced, which can improve the overall input accuracy of the touch screen interface 110.

Further, the concave nature of the focused entry depressions 135 can result in the area of the data entry-enhancing touch screen surface 130 between the focused entry depressions 135 to be thicker, providing an artificial, but physical and tactile barrier between the corresponding predefined input areas 125. Because the area between focused entry depressions 135 can be thicker, the sensitivity of these areas can be further reduced. That is, the thickness of the data entry-enhancing touch screen surface 130 at an area between focused entry depressions 135 can inhibit detection of the activation device, further decreasing incorrect entry selections.

The data entry-enhancing touch screen surface 130 can be intended for a temporary or removable placement upon the touch screen interface 110, as shown by FIG. 1, FIG. 1A, and FIG. 1B. As such, the data entry-enhancing touch screen surface 130 can be a distinct covering externally affixed to the touch screen interface 110 and/or computing device 105. A temporary nature can allow for a user to change the data entry-enhancing touch screen surface 130 to correspond with the associated GUI 115. For example, a user can utilize a keyboard surface 130 for a text messaging GUI 115 and a number pad surface 130 for a calculator GUI 115.

Attachment of the data entry-enhancing touch screen surface 130 can utilize a variety of means that can depend upon the specific embodiment. The data entry-enhancing touch screen surface 130 shown in system 100 can be secured utilizing a removable self-adhesive or a static electric charge. In FIG. 1A, the data entry-enhancing touch screen surface 130 can be integrated into an encapsulation jacket 145. The encapsulation jacket 145 can represent a sleeve-like container that the computing device 105 is placed within.

In FIG. 1B, the data entry-enhancing touch screen surface 130 can be affixed to the computing device 105 using a mechanical attachment mechanism 150 such as a hinge. The mechanical attachment mechanism 150 can allow for the positioning of the data entry-enhancing touch screen surface 130 to change in relation to the computing device 105. For example, the hinge 150 can be closed to position the data entry-enhancing touch screen surface 130 for data entry and then opened to view images. In one embodiment of FIG. 1B, the cover (surface 130) can be protective in nature in that it selectively encapsulates the device 105 providing protection from environmental hazards, while allowing guided (through depressions 135) entry of information.

Additionally, the touch screen interface 110 can be configured to detect the changes in the position of the data entry-enhancing touch screen surface 130 via the mechanical attachment mechanism 150 to produce corresponding changes in the touch screen interface 110. Expanding upon the previous example, the viewing mode of the can be automatically changed from portrait to landscape when the data entry-enhancing touch screen surface 130 is positioned away from the touch screen interface 110.

It should be noted that in the embodiments illustrated by FIG. 1, FIG. 1A, and FIG. 1B, it may be the responsibility of the user to ensure the alignment of the focused entry depressions 135 to the predefined input areas 125 when affixing a removable data entry-enhancing touch screen surface 130 to the touch screen interface 110.

In another contemplated embodiment, the data entry-enhancing touch screen surface 130 can be configured for a permanent attachment to the touch screen interface 110 and/or computing device 105. As shown in FIG. 1C, the data entry-enhancing touch screen surface 130 can be an integrated surface of the touch screen interface 110. Alternately, the data entry-enhancing touch screen surface 130 of system 100 can be made permanent by utilizing stronger adhering method, possibly performed during manufacture.

In yet another embodiment, the data entry-enhancing touch screen surface 130 can utilize an embedded capacitive sensor (not shown) to provide additional sensitivity data to the touch screen interface 110.

Although the depressions 135 are illustrated in system 100, any deviation from a touch surface of a touch screen interface 110 is contemplated. For example, in one contemplated embodiment, instead of depressions 135, raised regions (e.g., convex) can be aligned with corresponding focused input regions. In one embodiment, different graduations or levels can be imposed between different rows of the depressions. Similarly, raised lines (horizontal and/or vertical) can be used to separate the different rows of the depressions 135. In one embodiment, the depressions 135 can be implemented as protrusions, which can be convex regions or bumps positioned proximate to GUI elements. Additionally, a series of bumps and/or depressions can be intermixed, in a pattern designed to physically improve typing accuracy and speed via a touch screen interface 110 of computing device 105.

Additionally, the screen surface 130 is not to be construed as limited to being a planar surface. In one embodiment, the touch screen surface 130 can be curved, cornered, and possess other geometries. Regardless of geometry of the touch screen surface 130, a set of deviations (e.g., depressions 135) can be included that deviate from this surface to focus touches to a corresponding display region (e.g., predefined input areas 125).

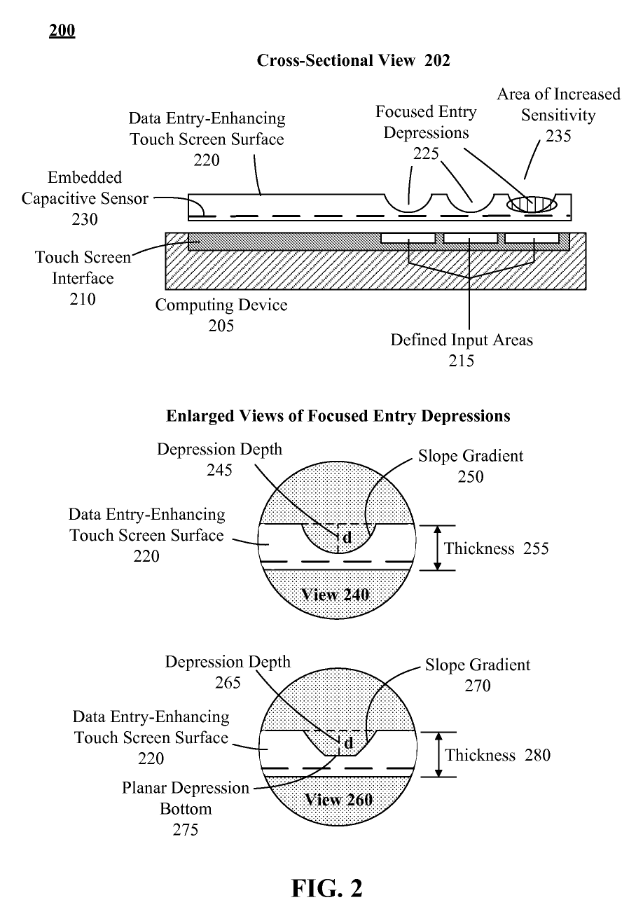

FIG. 2 is a collection 200 of alternate detailed views 202, 240, and 260 of a data entry-enhancing touch screen surface 220 in accordance with an embodiment of the inventive arrangements disclosed herein. The views 202, 240, and 260 of collection 200 can be extensions of the data entry-enhancing touch screen surface 130 illustrated in system 100. As with surface 130, surface 220 is not to be limited to a planar geometry, but can also include curved, cornered, and other geometries. Similarly, any deviation from the surface 220, be it convex, concave, trapezoidal, square, etc, can be used to focus input. For simplicity of expression, depressions 225 are illustrated and elaborated upon in FIG. 2, which is not to be construed as a limitation of this Application.

Collection 200 can include a cross-sectional view 202 and enlarged views 240 and 260 of the focused entry depressions of a data entry-enhancing touch screen surface 220. The cross-sectional view 202 can illustrate a data entry-enhancing touch screen surface 220 positioned upon the touch screen interface 210 of a computing device 205. The touch screen interface 210 can display one or more defined input areas 215.

It should be noted that the spacing shown between the data entry-enhancing touch screen surface 220 and the touch screen interface 210 in the cross-sectional view 202 is primarily for illustrative clarity, and, that the data entry-enhancing touch screen surface 220 can be in contact with the touch screen interface 210 without hindering function of this embodiment of the present invention. Further, a small spacing often exists between the multiple layers that comprise a touch screen interfaces 210. Therefore, the existence or non-existence of spacing between the data entry-enhancing touch screen surface 220 and the touch screen interface 210 is not adverse to the embodiments of the present invention.

The data entry-enhancing touch screen surface 220 can include one of more focused entry depressions 225 spatially aligned with the predefined input areas 215 of the touch screen interface 210. The focused entry depressions 225 can be configured to align with the center of the predefined input areas 215, so as to localize the input to the specific predefined input area 215. A central location of the focused entry depressions 225 with respect to their corresponding predefined input areas 215 can also increase the probability that an off-mark selection can be detected as intended by the touch screen interface 210.

Further, the data entry-enhancing touch screen surface 220 of the cross-sectional view 202 can illustrate the affect of an embedded capacitive sensor 230. The embedded capacitive sensor 230 can represent a sensor coated with a material that is capable of achieving capacitance when a continuous electrical current is applied. Indium-tin oxide (ITO) is a common material used for this purpose.

The use of an embedded capacitive sensor 230 allows for the generation of an area of increased sensitivity 235 at each focused entry depression 225. The reduced thickness of the data entry-enhancing touch screen surface 220 at these points can provide less resistance to the field of stored electrons generated by the embedded capacitive sensor 230 and more sensitivity to the introduction of an activation device into the focused entry depression 225.

Enlarged views 240 and 260 can illustrate the details of the focused entry depressions 225 of the data entry-enhancing touch screen surface 220. View 240 can illustrate a hemi-spherical focused entry depression 225 having a predefined depression depth (d) 245 and slope gradient 250.

View 240 can illustrate a focused entry depression 225 that descends at a predefined slope gradient 250 to a planar depression bottom 275 at a predefined depression depth (d) 265. Thus, the size and shape of the focused entry depressions 225 can be customized to provide additional versatility.

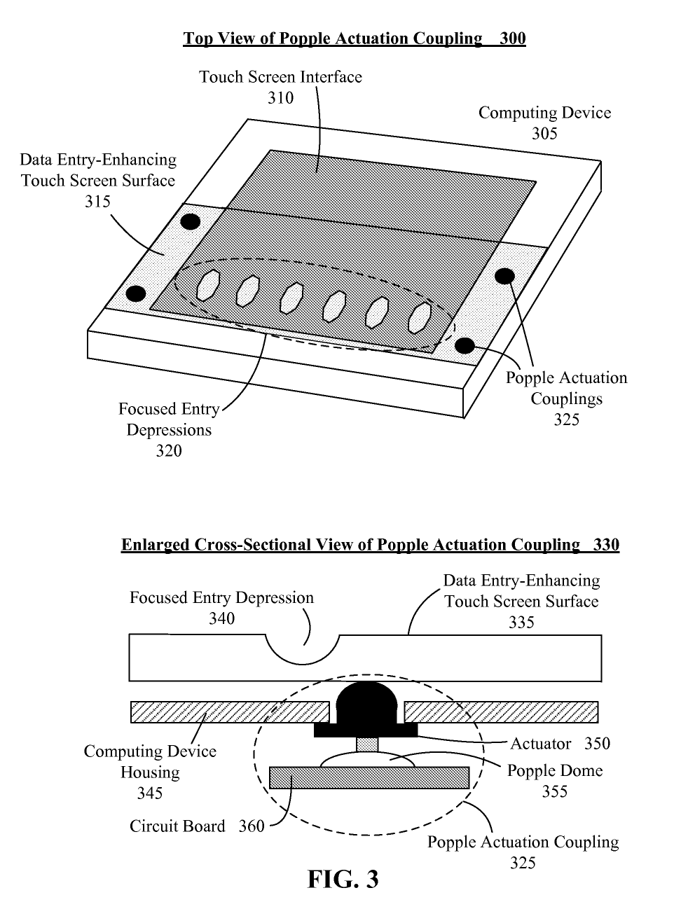

FIG. 3 contains schematic diagrams of views 300 and 330 that illustrate the use of popple actuation couplings 325 to differentiate sensations detected using the data entry-enhancing touch screen surface 315 in accordance with embodiments of the inventive arrangements disclosed herein. The views 300 and 330 of FIG. 3 can be used within the context of the embodiments of FIG. 1, FIG. 1A, FIG. 1B, FIG. 1C, and FIG. 2.

The top view 300 illustrates a computing device 305 having a touch screen interface 310 and multiple popple actuation couplings 325. A data entry-enhancing touch screen surface 315 having focused entry depressions 320 can be positioned over the touch screen interface 310 and popple actuation couplings 325. In one embodiment, the surface 315 can be removable, where the popple's are activated when the surface 315 is in place over interface 310 and are otherwise deactivated.

In one embodiment, the touch screen surface 315 can include touch input sensors capable of sensing touches. These sensed touches may be limited to regions corresponding to the focused entry depressions 320 or can sense touches for any region of the surface 315. When surface 315 includes touch sensors, these sensors can be electronically connected to device 305 electronics (e.g., directly wired or connected via an interface port, such as a USB port, a wireless USB port, etc.). The screen of computing device 305 can also (but need not in all embodiments) include sensors for detecting touches to the touch screen interface 310. In embodiment, where surface 315 lacks internal sensors, the surface 315 should be designed so that touch input sensors of device 305 are capable of detecting touch inputs (especially those directed to depressions 320), when surface 315 is in-place. In one embodiment, activation of popples can cause a touch sensitive of the interface 310 in a region corresponding to surface 315 to increase to ensure touches to surface 315 are properly acknowledged as input. When touch input sensors are present in both surface 315 and device 305, an activation state of the popples can be used to determine which input sensors (those of surface 315 or device 305) are to be active.

A touch screen interface 310 can often encounter numerous unintentional input sensations when handled. For example, when a user places a touch screen portable media device placed in a coat pocket, the touch screen interface 310 can receive unintentional input sensations as the user moves, even if the device is in a carrying case. If the touch screen interface 310 is configured to this degree of sensitivity, then extraneous and/or unintentional activations of the touch screen interface 310 can be filtered. Thus, different sensitivity states for accepting touch input can be established and can be programmatically altered depending upon an activation state of the popples.

The quantity and placement of popple actuation couplings 325 within the computing device 305 can be configured to provide a predetermined level of sensitivity for the area of the touch screen interface 310 covered by the data entry-enhancing touch screen surface 315. In one embodiment, different regions of the interface 310 can be associated with different removable touch screen surfaces 315, multiple ones of which may be concurrently utilized. For example, the region of the interface 310 can be separated into a “top” region, a “middle” region and a “bottom” region, each region having a different removable surface 315 associated with it. In another example, a region of the interface 310 can be separated into a top-right quadrant, a top-left quadrant, a bottom-right quadrant, and a bottom-left quadrant, each quadrant having a different removable surface 315 associated with it. When multiple removable surfaces 315 are concurrently used, an arrangement and quantity of the popple actuation couplings 325 can be sufficient to detect which (if any) of the surfaces 315 are active at any one time.

Function of the popple actuation coupling 325 can be further illustrated by the enlarged cross-sectional view 330. As shown in view 330, the popple actuation coupling 325 can be embedded within the computing device housing 345 in contact with the data entry-enhancing touch screen surface 335. It should be noted that the location of the popple actuation couplings 325 need not align with the focused entry depressions 320 of the data entry-enhancing touch screen surface 345.

The popple actuation coupling 325 can include an actuator 350 attached to a popple dome 355 that is connected to a circuit board 360. The actuator 350 can be configured to provide a predefined degree of resistance to forces exerted upon the data entry-enhancing touch screen surface 345. When an exerted force overcomes the predefined degree of resistance, the actuator 350 can recede into the popple dome 355.

Depression of the actuator 350 into the popple dome 355 can cause the shaft of the actuator 350 to come into contact with the circuit board 360. This can generate an electrical signal that can be captured and acted upon by the touch screen interface 310. The electrical signal generated by the depression of the actuator 350 can signify that the input sensation was made intentionally—a push input. Those input sensations that are detected, but are not accompanied by an electrical signal can be determined to be unintentional touch input sensations.

Therefore, if the touch screen interface 310 is configured to execute operations with only push input sensations, all other detected input sensations can be ignored, further increasing touch detection accuracy, while minimizing errors caused by overly sensitive device 305 touch sensors detecting inadvertent and non-deliberate touches. Alternately, the touch screen interface 310 can be configured to perform different operations in response to a push input sensation (where popples are activated) than in response to a touch input sensation (where popples are not activated). This can allow for the overloading of interface buttons based on this differentiation of downward force applied when touching a surface 315. For example, a touch with a popple deactivated can be interpreted by an OS of device 305 as a region selection event, while a touch to the same location with a popple deactivated can be interpreted by an OS of device 305 as a region selection event plus a left-click event.

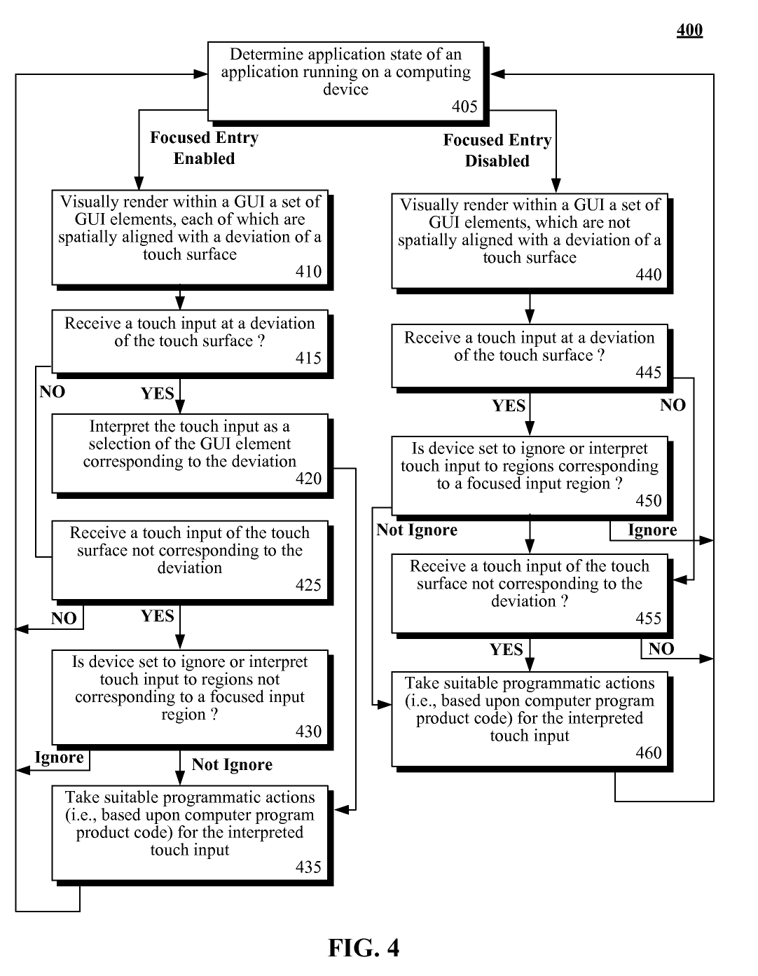

FIG. 4 is a flow chart of a method 400 for handling deviations to a touch surface within touch screen software in accordance with an embodiment of the inventive arrangements disclosed herein. In method 400, software can be included in a touch sensitive device, where the device can includes deviations in a touch surface to focus touch entry.

The method 400 can begin in step 405, where a determination is made as to an application state of an application running on a computing device. One application state can be a focused entry enabled state, where GUI elements of a rendered screen spatially align with deviations on a touch screen surface. Another application state can be an application state where GUI elements do not spatially aligned with deviations of the touch screen surface.

For example, a surface can include deviations forming a three by three matrix of deviations. An application state where focused entry is enabled can show numbers 1-9 in rows and columns, where a placement of each of the graphically rendered numbers corresponds to a deviation in the touch screen surface. The deviations can focus input towards the graphically rendered numbers. In a different application state, where focused entry is disabled, the three by three matrix of deviations can be spatially non-aligned with graphically rendered objects. For example, the application can render a picture or video, which does not have buttons (e.g., numbers 1-9) positioned in accordance with the deviations. Application behavior can vary depending upon the application state. Additionally, different application states can alter a manner in which received touch inputs are interpreted by the application.

In step 410, when focused entry is enabled, a set of GUI elements can be visually rendered within a display screen. GUI elements can be spatially aligned with deviations of the touch surface. In step 415, a check for an input to a region corresponding to a deviation can be made. If no such touch input is received, the method can progress from step 415 to step 425. When touch input in a surface deviation is detected, this touch input can be interpreted by the application as a selection of the GUI element corresponding to (e.g., spatially aligned with) the deviation, as shown by step 420. Step 435 shows that suitable programmatic actions can then be taken given the interpreted touch input. That is, a computer program product code can take actions associated with a deviation region touch (e.g., button touch) event having fired.

In step 425, a touch input to a touch surface region not corresponding to a deviation can be selectively detected. When a touch input is detected, the method can determine whether the device (application code) is set to interpret or ignore touch input to regions not corresponding (not spatially aligned with) to a focused input region (e.g., a deviation), as shown by step 430. When the input is not to be ignored, step 435 can occur, which causes a suitable programmatic action to execute. Programmatic actions of the running application may change application state, which is why the method is shown as looping back to step 405.

When the application is executing in a focused entry disabled state, a set of GUI element can be visually rendered, which are not spatially aligned with a deviation of the touch surface, as shown by step 440. A touch input may then be detected (step 445, 455). When an input is detected at a surface deviation, a check can be made as to whether the device (e.g., the running application) is to ignore or interpret such a touch input, as shown by step 450. When the touch input is not to be ignored, suitable programmatic actions can be taken, as shown by step 460. Touch input directed to other regions (not at a deviation) of the touch surface may be detected, as shown by step 455. When such a touch input is detected, suitable programmatic actions can be taken for that touch input, as shown by step 460. Programmatic actions may change application state, which is why the method loops from step 460 to step 405.

The diagrams in FIGS. 1-4 illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A system for improving touch screen data entry accuracy comprising:
a touch screen interface coupled with a computing device having a sensory system configured to detect touch input sensations from at least one predefined input area of a graphical user interface (GUI) rendered by the touch screen interface; and
a data entry-enhancing touch screen surface having at least one deviation from the surface for focusing touch entry to direct a touch input, wherein each deviation is spatially aligned with a predefined input area of the GUI.

2. The system of claim 1, wherein the data entry-enhancing touch screen surface is integrated within the touch screen interface, wherein the touch screen surface is a planar surface, and wherein the deviation is one of a projection and depression from the planar surface.

3. The system of claim 1, wherein each deviation is spatially aligned to a user selectable GUI element when the GUI is in a first application state, and wherein at least one application state exists where the deviation does not spatially align to a user selectable GUI element.

4. The system of claim 1, the data entry-enhancing touch screen surface comprising said deviation is selectively removable cover for a screen integrated into the computing device.

5. The system of claim 4, wherein the touch screen cover comprises at least one touch sensor electronically coupled to the device.

6. The system of claim 4, further comprising:
at least one popple actuation coupling configured to be activated only when said screen cover is attached to the computing device, which is used to programmatically detect a presence or absence of said touch screen cover.

7. The system of claim 1, wherein the deviation is convex, and wherein the deviation magnifies graphically rendered content of the predefined input area of the GUI to which it is spatially aligned.

8. The system of claim 1, wherein the sensory system of the touch screen interface utilizes at least one of resistive feedback sensing, capacitive sensing, optical imaging sensing.

9. The system of claim 5, further comprising:
at least one popple actuation coupling configured to be activated only when said screen cover is attached to the computing device, wherein input detected by the touch sensor of the touch screen cover is ignored by computing program products executing on the device when a popple of the popple actuation coupling is disabled and are processed as input when said popple is enabled.

10. The system of claim 1, wherein said at least one deviation comprises at least nine deviations, each deviation being spatially aligned with a different digit presented in the GUI.

11. A data entry-enhancing touch screen surface comprising:
at least one deviation from the touch screen surface for directing user touch input to spatially aligned regions of a graphical user interface (GUI) presented within a touch screen interface, wherein each deviation is spatially aligned with a predefined input area of the GUI, wherein each deviation biases touch input towards a corresponding predefined input area, wherein a software application running on a computing device that controls presented GUI comprises at least two application states, wherein in one application state, the deviations are spatially aligned with user selectable buttons rendered on the GUI, wherein in another of the application states, the deviations are not spatially aligned with user selectable buttons rendered on the GUI.

12. The data entry-enhancing touch screen surface of claim 11, wherein said at least one deviation comprises at least ten different deviations, each deviation being spatially aligned with a different user selectable buttons, wherein each of said user selectable buttons comprises a different rendered digit from one to ten.

13. The data entry-enhancing touch screen surface of claim 11, wherein said data entry-enhancing touch screen surface comprises a selectively removable cover for a screen integrated into a computing device.

14. The data entry-enhancing touch screen surface of claim 13, wherein said selectively removable touch screen cover comprises at least one touch sensor, selectively enabled only when the touch screen cover is positioned over the screen of the computing device.

15. The data entry-enhancing touch screen surface of claim 11, wherein said deviations comprise at least twelve deviations, each being a convex deviation inset into the touch screen surface, wherein said twelve deviations aligned in four vertical rows, each row comprising three vertically aligned deviations.

16. The data entry touch screen of claim 11, wherein said touch screen surface is one of a planar surface, a curved surface, and a cornered surface.

17. A method for focusing touch screen input of a computing device running an application using deviations in a touch surface comprising:
when in a first application state, visually rendering, via programmatic instructions executed by a processor, a plurality of GUI elements within a touch screen interface, wherein each of the plurality of GUI elements is spatially aligned with a deviation in a touch input surface, wherein a touch of the deviation is interpreted as input selecting the corresponding GUI element when in the first application state;
detecting an application event that causes a change from the first application state to a second application state;
automatically adjusting a graphical user interface from the first application state to the second application state responsive to detecting the application event, wherein in a second application state, the GUI elements associated with the first application state are changed, wherein when in the second application state, a touch of each deviation is interpreted differently than a similar touch would have been interpreted when in the first application.

18. The method of claim 17, further comprising:
when in the second application state, visually rendering a second plurality of GUI elements within the touch screen interface, wherein each of the second plurality of GUI elements is spatially aligned with a deviation.

19. The method of claim 17, further comprising;
when in the second application state, visually rendering a second plurality of GUI elements, wherein the second plurality of GUI elements are not spatially aligned with deviations.

20. The method of claim 18, wherein each of the deviations are depressions of a removable cover able to be positioned over of a touch screen device, said method further comprising:
detecting a change of usage state of the removable cover, responsive to the detected change of usage state, firing the application event that causes a change from the first application state to the second application state.
